(19) United States
(12) Patent Application Publication
(10) Pub. No.: US 2026/0204863 A1
(43) Pub. Date: Jul. 16, 2026

(54) METHOD OF CONTROLLING PEAK VALUE OF PULSED FIBER LASER

(71) Applicant: TOPCON CORPORATION, Tokyo (JP)

(72) Inventors: Taizo ENO, Tokyo (JP); Yoshiaki GOTO, Tokyo (JP); Shogo MIYANABE, Tokyo (JP)

(73) Assignee: TOPCON CORPORATION, Tokyo (JP)

(21) Appl. No.: 19/429,411

(22) Filed: Dec. 22, 2025

(30) Foreign Application Priority Data
Jan. 16, 2025 (JP) 2025-006001

(51) Int. Cl. H01S 3/091; G01S 7/484; H01S 3/094; H01S 3/0941

(52) U.S. Cl. CPC H01S 3/0912; G01S 7/484; H01S 3/094003; H01S 3/094076; H01S 3/09415

(57) ABSTRACT

A distance measurement method which measures a distance by irradiating an object 3 with pulsed light from a pulsed fiber laser device 10, receiving reflected pulsed light of the irradiation pulsed light being reflected by the object, and converting a time interval from projection of the irradiation pulsed light to reception of the reflected pulsed light into a distance, includes detecting the irradiation pulsed light and the reflected pulsed light by an avalanche photodiode 21, calculating a peak value of the irradiation pulsed light based on the detection of the irradiation pulsed light, and controlling the peak value of the irradiation pulsed light to be generated so as to be constant based on the calculated peak value.

### TECHNICAL FIELD

The disclosure relates to a method of controlling a peak value of a pulsed fiber laser in distance measurement based on a so-called time-of-flight method using a pulsed fiber laser.

### BACKGROUND ART

Conventionally, various methods are known as distance measurement based on a time-of-flight method, which measures a distance by irradiating an object with pulsed light from a pulsed laser, receiving reflected pulsed light of the irradiation pulsed light being reflected by the object, and converting a time interval from projection of the irradiation pulsed light to reception of the reflected pulsed light into a distance.

For example, Patent Literature 1 discloses a distance measurement method in which pulsed laser light is emitted by a semiconductor laser, the laser light is branched into an object wave (irradiation wave) with which an object is irradiated and a reference wave by a beam splitter, a reflected wave of the object wave by an object and the reference wave are received by one photodiode, a signal component output from the photodiode is separated into a reflected signal component corresponding to the reflected wave and a reference signal component corresponding to the reference wave in a mask circuit, for each of the reflected signal component and the reference signal component, an operation of triggering the semiconductor laser by using a signal delayed by a delay circuit is repeated until count-up of a counter and its time is integrated, a time obtained for the reference signal component is subtracted from a time obtained for the reflected signal component to obtain a time interval corresponding to a distance to the object, and the time interval is converted into a distance.

### CITATION LIST

### Patent Literature

Patent Literature 1: JP 2001-124855 A1

### SUMMARY

### Technical Problem

A light amount of a reflected wave changes according to the reflectance of a surface of an object or a distance to the object. The conventional distance measurement method disclosed in Patent Literature 1 copes with this change by keeping the amplitude of the reflected signal component output from an amplifier circuit constant by using a gain adjustment circuit and an APC circuit. However, since a reflected wave pulse is an object wave pulse reflected by the object, when an emitted object wave pulse is unstable, a received reflected wave pulse is also unstable. It is known that a reach distance of the object wave pulse is related to its peak output rather than its average output.

When a peak value of the object wave pulse fluctuates and becomes small due to a cause, for example, a change in environmental temperature, the reach distance of the object wave pulse becomes short, which causes a situation in which an object at a distance that was previously within a detectable range becomes undetectable, or even if the object wave reaches the object, the light amount of the reflected wave pulse falls below a certain value, so that the photodiode fails to detect the reflected wave. Further, the conventional measurement method has a limitation to cope with this situation, as the conventional method copes with the change in the light amount of the received reflected wave pulse by keeping the amplitude of the reflected signal component constant.

The disclosure has been made to solve the above-described problems, and an object of the disclosure is to provide a method of controlling a peak value of a pulse wave in a distance measurement method using a pulsed fiber laser, which is capable of maintaining a stable reach distance by keeping a peak value of a pulse wave irradiated onto an object constant, thereby enabling reliable distance measurement.

### Solution to Problem

In order to achieve the above object, a first aspect of the present disclosure provides a method of controlling a peak value of a pulsed fiber laser including, in a distance measurement method of measuring a distance by irradiating an object with pulsed light from the pulsed fiber laser, receiving reflected pulsed light of the irradiation pulsed light being reflected by the object, and converting a time interval from projection of the irradiation pulsed light to reception of the reflected pulsed light into a distance, including detecting the irradiation pulsed light and the reflected pulsed light by using an avalanche photodiode (hereinafter referred to as an “APD”), calculating a peak value of the irradiation pulsed light on the basis of the detection, and controlling the peak value of the irradiation pulsed light to be generated to be constant based on the calculated peak value.

Similarly, to achieve the above object, according to a second aspect of the method of controlling a peak value of a pulsed fiber laser of the present disclosure, in the first aspect, a current value of the irradiation pulsed light detected by the APD is converted into a voltage value, then A/D-converted, and input to peak calculation means, for example, a field-programmable gate array (hereinafter referred to as an “FPGA”), and the FPGA calculates a peak value of the irradiation pulsed light, outputs a drive control signal to an excitation laser diode driver circuit (hereinafter referred to as an “excitation LD driver circuit”) which drives an excitation laser diode (hereinafter referred to as an “excitation LD”) that emits excitation light to an amplification fiber that generates irradiation pulsed light of the pulsed fiber laser, based on the calculated peak value, such that the peak value of the generated irradiation pulsed light becomes constant, and outputs a drive control signal to a pulse laser diode driver circuit (hereinafter referred to as a “pulse LD driver circuit”) which drives a pulse laser diode (hereinafter referred to as a “pulse LD”) that emits a seed laser pulse to the amplification fiber.

Similarly, to achieve the above object, according to a third aspect of the method of controlling a peak value of a pulsed fiber laser of the present disclosure, in the first and second aspects, the peak value of the irradiation pulsed light is calculated by interpolating sampled values.

Similarly, to achieve the above object, according to a fourth aspect of the method of controlling a peak value of a pulsed fiber laser of the present disclosure, in the first and second aspects, the calculated peak value of the irradiation pulsed light is an average value of a plurality of irradiation pulsed light peak values.

Further, as an example of an apparatus to which the method of controlling a peak value of a pulsed fiber laser according to the present disclosure is applied, a distance measurement apparatus which measures a distance by irradiating an object with pulsed light from a pulsed fiber laser, receiving reflected pulsed light of the irradiation pulsed light being reflected by the object, and converting a time interval from projection of the irradiation pulsed light to reception of the reflected pulsed light into a distance, includes an amplification fiber that generates the irradiation pulsed light, an APD that detects the reflected pulsed light and detects a peak value of the irradiation pulsed light, a pulse LD that is controlled by a pulse LD driver circuit so as to emit seed laser light for generating the irradiation pulsed light to the amplification fiber, an FPGA that outputs a drive current corresponding to the peak value of the irradiation pulsed light to an excitation LD driver circuit, and an excitation LD that is driven and controlled by the excitation LD driver circuit, and emits excitation light to the amplification fiber such that the amplification fiber generates pulsed light having a peak value the same as the peak value of the irradiation pulsed light detected by the APD.

### Advantageous Effects

According to the disclosure, keeping a peak value of pulsed light of a pulsed fiber laser irradiated onto an object constant allows for maintaining a stable reach distance, thereby enabling reliable distance measurement.

### BRIEF DESCRIPTION OF DRAWINGS

FIG. 1 is a block diagram illustrating an embodiment of a distance measurement apparatus to which a method of controlling a peak value of a pulsed fiber laser according to the disclosure is applied.

FIG. 2 is a schematic diagram illustrating waveforms of an irradiation pulse and a reflected pulse detected by an APD.

FIG. 3 is a schematic diagram illustrating sampling data of reflected pulsed light detected by an APD.

FIG. 4 is a schematic diagram illustrating a comparison between a peak value and an average value of the irradiation pulsed light detected by an APD.

### DESCRIPTION OF EMBODIMENTS

Hereinafter, an embodiment of a distance measurement apparatus to which a method of controlling a peak value of a pulsed fiber laser according to the present disclosure is applied will be described with reference to the accompanying drawings.

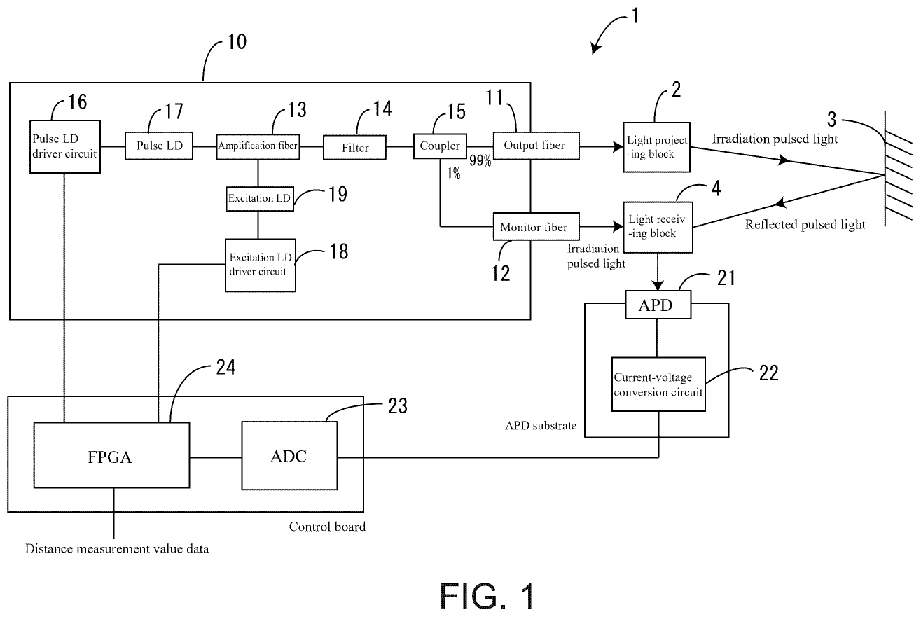

As illustrated in FIG. 1, a distance measurement apparatus 1 uses a time-of-flight method in which an object 3 is irradiated with irradiation pulsed light emitted from an output fiber 11 of a pulsed fiber laser device 10 via a light projecting block 2, reflected pulsed light of the irradiation pulsed light being reflected by the object 3 is incident on a light receiving block 4, and a time interval from the emission of the irradiation pulsed light to the incidence of the reflected pulsed light is converted into a distance to measure a distance. The pulsed fiber laser device 10 includes a monitor fiber 12 in addition to the output fiber 11, and the pulsed light emitted from the monitor fiber 12 is incident on the light receiving block 4.

The pulsed fiber laser device 10 includes an amplification fiber 13 that generates irradiation pulsed light. A seed laser pulse is incident on the amplification fiber 13. The seed laser pulse is emitted from a pulse LD 17 that is controlled with a drive signal of a pulse LD driver circuit 16. In addition, an excitation pulse is incident on the amplification fiber 13. The excitation pulse is emitted from an excitation LD 19 controlled with a drive signal of an excitation LD driver circuit 18. The excitation LD 19 is driven and controlled by the excitation LD driver circuit 18, and emits excitation light that is CW laser light to the amplification fiber 13 such that the amplification fiber 13 generates irradiation pulsed light having a peak value the same as a peak value of the irradiation pulsed light detected by an APD 21 that will be described later.

The irradiation pulsed light generated by the amplification fiber 13 is transmitted by a filter 14 in a desired wavelength band, for example, in a range of 1550±1 nm. The generated irradiation pulsed light is branched by a coupler 15, and branched light components are respectively sent to the output fiber 11 and the monitor fiber 12. A branching ratio is 99% on the output fiber 11 side, and the remaining 1% on the monitor fiber 12 side. As described above, the irradiation light pulse is irradiated from the output fiber 11 onto the object 3 via the light projecting block 2, and the reflected light pulse is incident on the light receiving block 4.

The reflected pulsed light incident on the light receiving block 4 and the irradiation pulsed light from the monitor fiber 12 are incident on the APD 21, and the APD 21 detects the reflected pulsed light, detects a peak value of the irradiation pulsed light, and outputs the peak value as a current value. The output current value is converted into a voltage value by a current-voltage conversion circuit 22, further digitally converted by an A/D conversion circuit (ADC) 23, and input to an FPGA 24 that is peak calculation means. The FPGA 24 calculates a peak value of the irradiation pulsed light, outputs a drive current control signal corresponding to the peak value to the excitation LD driver circuit 18, and outputs a drive current control signal corresponding to the calculated peak value to the pulse LD driver circuit 16. In addition, the FPGA 24 outputs a distance to the object 3 measured by using the time-of-flight method as distance measurement value data.

Subsequently, a method of controlling a peak value of a pulsed fiber laser in the distance measurement apparatus 1 described above will be described in greater detail.

99% of the irradiation pulsed light emitted from the output fiber 11 is irradiated from the light projecting block 2 onto the object 3, and the reflected pulsed light of the irradiation pulsed light being reflected by the object 3 is incident on the light receiving block 4. On the other hand, 1% of the irradiation pulsed light emitted from the monitor fiber 12 is incident on the light receiving block 4 simultaneously with 99% of the irradiation pulsed light emitted from the output fiber 11. A time interval corresponding to the distance to the object 3 is obtained by subtracting the time required for 1% of the irradiation pulsed light to travel from the monitor fiber 12 and reach the light receiving block 4 from the time required for 99% of the irradiation pulsed light to be emitted from the output fiber 11 and reach the light receiving block 4 as reflected pulsed light. Converting this time interval into a distance allows for obtaining the distance to the object 3.

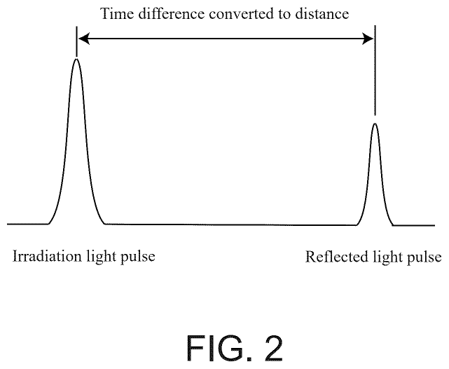

The incidence of 1% of the irradiation pulsed light and the reflected pulsed light on the light receiving block 4 is detected by the APD 21. The APD 21 has ultrafast responsiveness, and can thus detect a peak value of each pulse as illustrated in FIG. 2. The APD 21 first detects 1% of the irradiation pulsed light as a current value, and then, detects the reflected pulsed light as a current value with a time delay according to the distance from the light projecting block 2 to the object 3. These current values are converted into voltages by the current-voltage conversion circuit 22, further subjected to A/D conversion by the A/D converter (ADC) 23, and input to the FPGA 24.

The FPGA 24 calculates a peak value of the input irradiation pulsed light, and outputs a drive control signal to the excitation LD driver circuit 18 that drives the excitation LD 19, based on the calculated peak value. The excitation LD driver circuit 18 outputs a drive signal to the excitation LD 19 based on the drive control signal. The excitation LD 19 outputs CW laser light being excitation light to the amplification fiber 13 based on the drive signal such that the peak value of the irradiation pulsed light generated by the amplification fiber 13 becomes constant. In addition, the FPGA 24 outputs a drive control signal to the pulse LD driver circuit 16 so as to emit a seed laser pulse from the pulse LD 17 to the amplification fiber 13. The seed laser pulse is amplified by the amplification fiber 13 to generate irradiation pulsed light.

As described above, the FPGA 24 controls the peak value of the irradiation pulsed light detected by the APD 21 to be constant. That is, controlling the peak value of the irradiation pulsed light emitted from the monitor fiber 12 to be constant makes the peak value of the irradiation pulsed light emitted from the output fiber 11 constant.

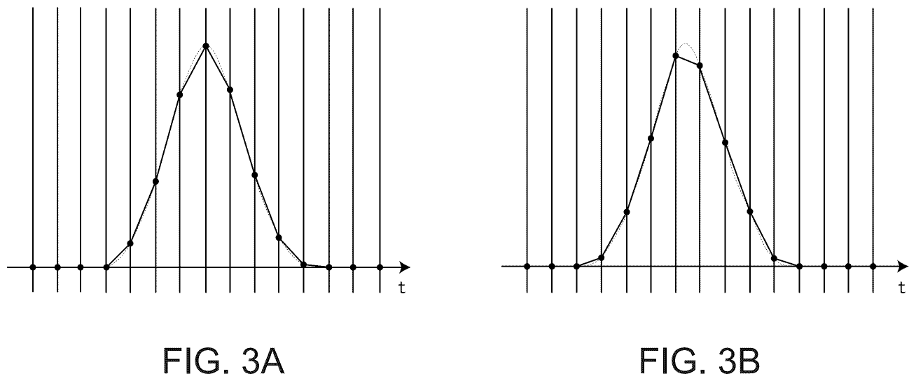

For the calculation of the peak value of the irradiation pulsed light, as illustrated in FIGS. 3A and 3B, an accurate peak value can be calculated when the peak value matches a sampling point at the time of A/D conversion using the A/D converter 23 (see FIG. 3A), but the peak value may mismatch the sampling point (see FIG. 3B). When the peak value mismatches the sampling point, an inaccurate peak value is calculated. Therefore, it is preferable to increase the accuracy of the calculation of the peak value of the irradiation pulsed light by using an interpolation method such as spline interpolation. A dotted line portion illustrated in FIGS. 3A and 3B is an interpolated curve.

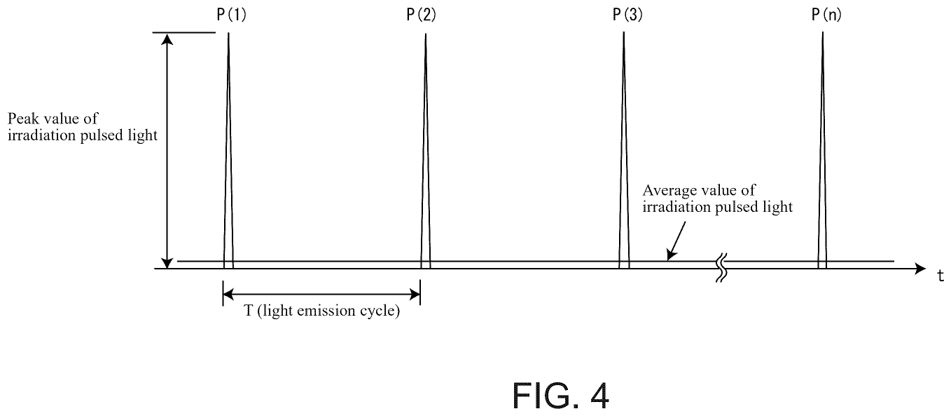

In addition, an average value of a plurality of peak values P1, P2, P3, . . . , and Pn of the irradiation pulsed light detected by the APD 21 may be set as a peak value of the irradiation pulsed light, and the average peak value may be used as a reference for control. As illustrated in FIG. 4, the average value of the peak values detected by the APD 21 is significantly greater than the average output value of the irradiation pulsed light detected by a conventional photodiode. Accordingly, the signal-to-noise (SN) ratio is improved compared with conventional systems, thereby enhancing robustness.

Further, amplified spontaneous emission (hereinafter referred to as “ASE”) is CW light that passes through the filter 14 having a bandwidth of 1 nm centered at 1550 nm and leaks out a few percent as part of an irradiation pulse. Since the ASE varies depending on the pulse repetition frequency and the ambient temperature, the ASE content ratio can be greatly reduced by automatic power control (hereinafter referred to as “APC”) based on the peak value of the irradiation pulsed light compared with APC based on the average value of the irradiation pulsed light in FIG. 4. In addition, since the peak value of the irradiation pulsed light contributes to the reach distance of the irradiation pulsed light, it is desirable to perform APC using information of the peak value excluding ASE as much as possible.

Note that the disclosure is not limited to the above-described embodiment, and for example, the wavelength band of the irradiation pulsed light transmitted through the filter 14 is not limited to 1550±1 nm. The ratio of branching of the irradiation pulsed light to the output fiber 11 and the monitor fiber 12 by the coupler 15 is not limited to 99% and 1%. Furthermore, the peak calculation means is not limited to an FPGA, and may be other means such as an application specific integrated circuit (ASIC).

### REFERENCE SIGNS LIST

1 Distance measurement apparatus
2 Light projecting block
3 Object
4 Light receiving block
10 Pulsed fiber laser device
11 Output fiber
12 Monitor fiber
13 Amplification fiber
14 Filter
15 Coupler
16 Pulse LD driver circuit
17 Pulse LD
18 Excitation LD driver circuit
19 Excitation LD
21 APD
22 Current-voltage conversion circuit
23 A/D converter (ADC)
24 FPGA

1. A method of controlling a peak value of a pulsed fiber laser comprising: in a distance measurement method of measuring a distance by irradiating an object with pulsed light from the pulsed fiber laser, receiving reflected pulsed light of the irradiation pulsed light being reflected by the object, and converting a time interval from projection of the irradiation pulsed light to reception of the reflected pulsed light into a distance,
detecting the irradiation pulsed light and the reflected pulsed light by using an avalanche photodiode; calculating a peak value of the irradiation pulsed light on the basis of the detection of the irradiation pulsed light; and controlling the peak value of the irradiation pulsed light to be generated to be constant based on the calculated peak value.

2. The method of controlling a peak value of a pulsed fiber laser according to claim 1, wherein
a current value of the irradiation pulsed light detected by the avalanche photodiode is converted into a voltage value, then A/D-converted, and input to peak calculation means, and
the peak calculation means calculates a peak value of the irradiation pulsed light, outputs a drive control signal to an excitation laser diode driver circuit which drives an excitation laser diode that emits excitation light to an amplification fiber that generates the irradiation pulsed light of the pulsed fiber laser, based on the calculated peak value, such that the peak value of the generated irradiation pulsed light becomes constant, and outputs a drive control signal to a pulse laser diode driver circuit which drives a pulse laser diode that emits a seed laser pulse to the amplification fiber.

3. The method of controlling a peak value of a pulsed fiber laser according to claim 1, wherein
the peak value of the irradiation pulsed light is calculated by interpolating sampled values.

4. The method of controlling a peak value of a pulsed fiber laser according to claim 2, wherein
the peak value of the irradiation pulsed light is calculated by interpolating sampled values.

5. The method of controlling a peak value of a pulsed fiber laser according to claim 1, wherein
the calculated peak value of the irradiation pulsed light is an average value of a plurality of irradiation pulsed light peak values.

6. The method of controlling a peak value of a pulsed fiber laser according to claim 2, wherein
the calculated peak value of the irradiation pulsed light is an average value of a plurality of irradiation pulsed light peak values.
